(19) United States
(12) Patent Application Publication
(10) Pub. No.: US 2009/0225014 A1
(43) Pub. Date: Sep. 10, 2009

(54) CONTROL OF SEMICONDUCTOR LIGHT EMITTING ELEMENT

(75) Inventor: Tomio IKEGAMI, Chino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/398,689

(22) Filed: Mar. 5, 2009

(30) Foreign Application Priority Data
Mar. 6, 2008 (JP) 2008-056036

(51) Int. Cl. G09G 3/32; H05B 41/36

(52) U.S. Cl. 345/82; 315/307

(57) ABSTRACT

A light source device including a semiconductor light emitting element and a control section adapted to control the light emitting element in accordance with an input value. The control section includes a characteristic value calculation section adapted to calculate a characteristic value representing a characteristic of the light emitting element in accordance with a measurement value, a current supply section adapted to supply the light emitting element with a drive current based on the characteristic value, the input value, and an estimation value of a threshold current of the light emitting element, and an estimation section adapted to obtain the estimation value of the threshold current used in the current supply section using a value of the drive current, a light amount detection value related to an amount of light emitted from the light emitting element, and the characteristic value.

### BACKGROUND OF THE INVENTION

The entire disclosure of Japanese Patent Application No. 2008-056036, filed Mar. 6, 2008 and is expressly incorporated herein by reference.

1. Technical Field

The present invention relates to a semiconductor light emitting element. More specifically, the present invention relates to a system and method for controlling a semiconductor light emitting element.

2. Related Art

Projectors have traditionally used high-pressure mercury lamps as light sources. More recently, semiconductor lasers have been used as a projector light source. For example, Japanese Publication No. JP-A-2000-294871 and U.S. Pat. No. 6,243,407 each describe examples of projectors which use semiconductor lasers as a light source.

When a semiconductor laser is used as the light source, the intensity or emission amount of light emitted from the semiconductor laser can be varied due to heat generation even when the input value sent to the semiconductor laser remains constant. In this case, the image displayed by the projector can be different from the image represented by the image data. This phenomenon becomes even more prominent in, for example, situations where the semiconductor laser uses the thermal lens effect.

It should be noted this problem occurs not only in semiconductor lasers but also in other semiconductor light emitting elements such as light emitting diodes. Further, the problem described above is not limited to the projectors, but common to the light source devices which include semiconductor light emitting elements.

### BRIEF SUMMARY OF THE INVENTION

An advantage of some aspects of the invention is to make the semiconductor light emitting element emit the light having intensity corresponding to the input value accurately.

Systems and methods of the invention are directed to a light source device including a semiconductor light emitting element, and a control section adapted to control the semiconductor light emitting element in accordance with an input value which includes a characteristic value calculation section adapted to calculate a characteristic value representing an input-output characteristic of the semiconductor light emitting element in accordance with a measurement value related to the semiconductor light emitting element, a current supply section adapted to supply the semiconductor light emitting element with a drive current based on the characteristic value, the input value, and an estimation value of a threshold current of the semiconductor light emitting element, and an estimation section adapted to obtain the estimation value of the threshold current used in the current supply section, using a value of the drive current, a light amount detection value related to an amount of light emitted from the semiconductor light emitting element, and the characteristic value.

In the light source device described herein, a characteristic value representing the characteristic of the semiconductor light emitting element and the estimation value of the threshold current are obtained. A drive current corresponding thereto is supplied to the semiconductor light emitting element even when the characteristic thereof varies in accordance with the temperature of the light source device. Therefore, even in the case in which the characteristic of the semiconductor light emitting element varies due to the temperature variation, it becomes possible to accurately emit light from the semiconductor light emitting element with the intensity corresponding to the input value.

It should be noted that the invention can be put into practice in various forms such as a light source device including a semiconductor light emitting element, control device and method for a semiconductor light emitting element, an image display device equipped with a light source device, control device and method for the image display device, a computer program for realizing the function of the method or the device, a recording medium storing the computer program, or a data signal including the computer program and realized in a carrier wave.

### BRIEF DESCRIPTION OF THE DRAWINGS

The invention will be described with reference to the accompanying drawings, wherein like numbers reference like elements.

FIG. 1 is an explanatory diagram showing a schematic configuration of a projector;

FIGS. 2A and 2B are explanatory diagrams schematically showing a method of operating the projector of FIG. 1;

FIGS. 3A-3E are timing charts showing the operation of a light source device as currently performed in the art;

FIG. 4 is an explanatory diagram showing a schematic configuration of a light source device;

FIGS. 5A-5C are explanatory diagrams illustrating the function of a differential efficiency adjustment section;

FIG. 6 is an explanatory diagram showing an internal configuration of a current driver;

FIGS. 7A-7E are timing charts showing a method of operating a light source device;

FIG. 8 is an explanatory diagram showing a specific configuration of a light source device;

FIG. 9 is an explanatory diagram showing a circuit diagram of a light source device;

FIG. 10 is an explanatory diagram showing a circuit diagram of a light source device;

FIG. 11 is a block diagram showing a schematic configuration of a differential efficiency adjustment section;

FIGS. 12A-12D are explanatory diagrams showing schematic configurations of an operation section of the differential efficiency adjustment section;

FIG. 13 is an explanatory diagram showing a circuit diagram of the differential efficiency adjustment section;

FIGS. 14A and 14B are explanatory diagrams illustrating another example of the method of calculating an integration value of a product of a light amount error and a grayscale value; and

FIG. 15 is an explanatory diagram showing another example of the circuit diagram of the differential efficiency adjustment section.

### DESCRIPTION OF EXEMPLARY EMBODIMENTS

Some embodiments of the invention will hereinafter be explained based on some specific examples in the following order.
A. Embodiments
   A-1. Configuration of Projector
   A-2. Comparative Example
   A-3. Configuration of Light Source Device
   A-4. Operation of Light Source Device
   A-5. Threshold Current Estimator
   A-6. Differential Efficiency Adjustment Section
B. Modified Examples

### A. EMBODIMENTS

### A-1. CONFIGURATION OF PROJECTOR

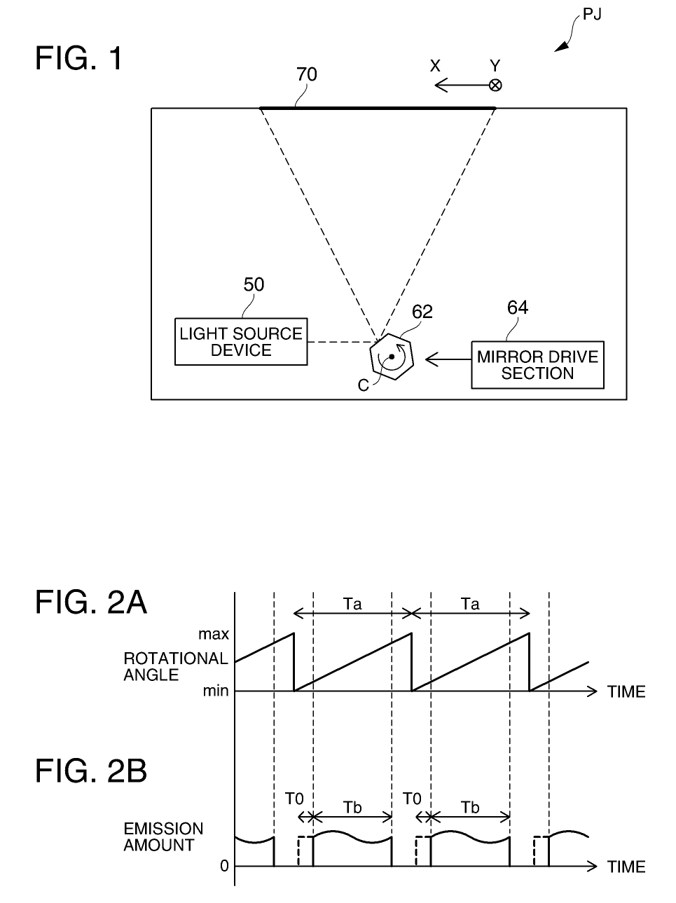

FIG. 1 is an explanatory diagram showing a schematic configuration of a projector PJ. The projector PJ is a so-called raster scanning type rear projector. The projector PJ is provided with a light source device 50, a polygon mirror 62, a mirror drive section 64, and a screen 70.

The light source device 50 is provided with a semiconductor laser which emits a laser beam from the light source device 50. Specifically, the light source device 50 emits light at an intensity which corresponds to pixel data (pixel values) in order to form the image data. The polygon mirror 62 includes a plurality of mirror surfaces, and each of the mirror surfaces reflects the light emitted from the light source device 50 towards the screen 70. The mirror drive section 64 rotates the polygon mirror 62 around the center axis C in the counterclockwise direction. Therefore, the light formed on the screen 70 is scanned on the screen 70 in the X-direction. Further, the mirror drive section 64 turns the polygon mirror 62 around an axis which is parallel to the X-direction. Therefore, the scan line of the spot of the light moves gradually in a Y direction. The screen 70 is a diffusing plate, and diffuses the incident light. As a result, the image represented by the image data is displayed on the screen 70. It should be noted that the observer observes the image using the afterimage phenomenon.

FIGS. 2A and 2B are explanatory diagrams schematically showing the operation of the projector PJ. FIG. 2A shows the rotational angle of the polygon mirror 62, and the lower part and FIG. 2B shows the intensity or emission amount of light emitted from the light source device 50.

The rotational angle of the polygon mirror 62 shown in FIG. 2A represents the rotational angle of the object mirror surface to which the light emitted from the light source device 50 is input. A base period Ta represents the period during which the laser beam enters the object mirror surface, assuming that the laser beam is constantly emitted from the light source device 50. The starting point of the base period Ta corresponds to the minimum value (min) of the rotational angle of the object mirror surface, and the end point of the base period Ta corresponds to the maximum value (max) of the rotational angle of the object mirror surface. In the present embodiment, as shown in FIG. 2B, the light source device 50 emits light only in an effective period Tb, which is only a portion of the base period Ta. Therefore, only a partial image or line image corresponding to one scan line is drawn when the rotational angle of the object mirror surface is increased in the effective period Tb. It should be noted that the period T0 shown in FIG. 2B will be more fully below.

Incidentally, in the raster scanning type projector PJ described above, the intensity of the light emitted from the light source device 50 preferably has an intensity that corresponds to the pixel data. However, as previously described, the intensity of the light emitted from the semiconductor laser can vary depending on the temperature of the semiconductor laser 52. Therefore, the intensity of the light emitted from the light source device 50 could have an intensity which does not correspond to the pixel data.

### A-2. COMPARATIVE EXAMPLE

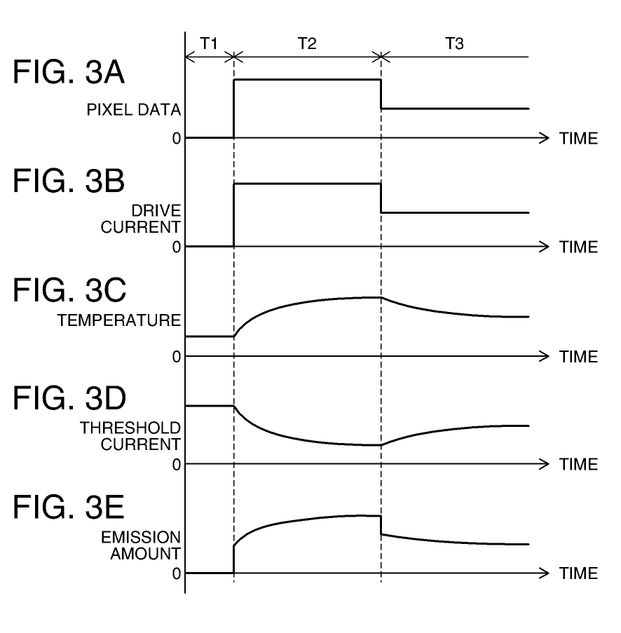

FIG. 3 is a timing chart showing an operation of a light source device currently known in the art as a comparative example. FIG. 3A shows the pixel data provided to the light source device. FIG. 3B shows the drive current supplied to a semiconductor laser. FIG. 3C shows the temperature of the semiconductor laser. FIG. 3D shows the threshold current of the semiconductor laser. FIG. 3E shows the intensity of the light emitted from the semiconductor laser.

As shown in FIG. 3A, the pixel data stays in zero during the period T1, has a relatively large value during the period T2, and has a relatively small value during the period T3. As shown FIG. 3B, the drive current of the semiconductor laser is set to the value corresponding to the pixel data. More specifically, the drive current of the semiconductor laser is set to zero during the period T1, has a large value during the period T2, and has a relatively small value during the period T3.

As the drive current varies, the temperature of the semiconductor laser varies as, for example, shown FIG. 3C. Specifically, the temperature of the semiconductor laser increases gradually during the period T2 after the drive current has been set to a constant value, and then gradually drops during the period T3 after the drive current has been reduced. Further, as the temperature of the semiconductor laser varies, the threshold current of the semiconductor laser varies, as shown in FIG. 3D. Specifically, the threshold current of the semiconductor laser decreases as the temperature rises in the period T2, while increases as the temperature drops during the period T3. As a result, as shown FIG. 3E, the emission amount of the semiconductor laser increases rapidly and then gently increases during the period T2, and decreases rapidly and then gently decreases during the period T3.

The profile of the emission amount shown FIG. 3E is preferably equivalent or similar to the profile of the pixel data shown in FIG. 3A. However, as may be observed from the comparison between FIG. 3A and FIG. 3E, the two profiles are significantly different from each other. This is because the threshold current is significantly varied due to the change in temperature of the semiconductor laser as shown in FIG. 3D.

If the light source device currently known in the art, even in the case in which a solid image or image with even luminance is supposed to be displayed on the screen, an image with a distributed luminance may be generated. More specifically, it is assumed that each of the line images of the solid image is drawn from a first side to a second side. When the first side of each of the line images is drawn, the emission amount is relatively small because the temperature of the semiconductor laser is relatively low, and the threshold current is relatively high. In contrast, when the second side of each of the line images is drawn, the emission amount is relatively large because the temperature of the semiconductor laser is relatively high, and the threshold current is relatively low. As a result, the luminance of the first side of the solid image displayed on the screen is lower than the luminance in the second side.

Therefore, in the present embodiment, the configuration of the light source device 50 is devised so that the profile of the emission amount is equivalent or the same as the profile of the pixel data.

It should be noted that the problem shown in FIG. 3 becomes even more prominent in, for example, a semiconductor laser where a thermal lens effect is used. Specifically, when the temperature of the semiconductor laser is increased in accordance with the drive current, the threshold current decreases, thus the emission amount of the semiconductor laser increases. By contrast, when the temperature of the semiconductor laser is low in accordance with the drive current, the threshold current becomes large, thus the emission amount of the semiconductor laser decreases. Here, the thermal lens effect denotes the phenomenon that occurs when irradiation with the laser beam causes the local elevation of temperature, which in turn generates the refractive index distribution.

### A-3. CONFIGURATION OF LIGHT SOURCE DEVICE

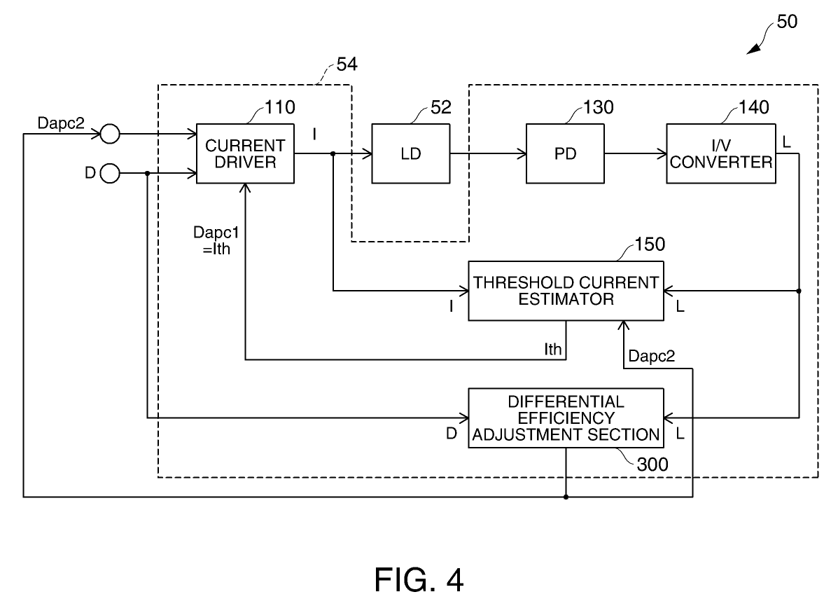

FIG. 4 is an explanatory diagram showing a schematic configuration of the light source device 50 of FIG. 1. As shown FIG. 4, the light source device 50 is provided with a semiconductor laser (LD) 52 and a control circuit 54 for controlling the operation of the semiconductor laser 52. The semiconductor laser 52 uses the thermal lens effect. The control circuit 54 is provided with a current driver 110, a light-sensitive element (PD) 130, a current-to-voltage (I/V) converter 140, a threshold current estimator 150, and a differential efficiency adjustment section 300.

The current driver 110 supplies the semiconductor laser 52 with a drive current I corresponding to a threshold current command value Dapc1, a grayscale current command value Dapc2, and the pixel data D. These three signals Dapc1, Dapc2, and D will be described more fully below.

The semiconductor laser 52 emits the laser beam in accordance with the drive current I supplied from the current driver 110.

The light-sensitive element 130 outputs the current corresponding to the intensity of the light emitted from the semiconductor laser 52.

The I/V converter 140 outputs the voltage corresponding to the current received from the light-sensitive element 130. The voltage output from the IV converter 140 depends on the intensity of the light emitted from the semiconductor laser 52. Therefore, the voltage output from the I/V converter 140 is also hereinafter simply referred to as “the emission amount L.”

The threshold current estimator 150 estimates the threshold current Iₜₕ of the semiconductor laser 52 using the voltage or emission amount L output from the I/V converter 140 and the drive current I supplied from the current driver 110 to the semiconductor laser 52. The estimated threshold current Iₜₕ is fed-back to the current driver 110 in real time as the threshold current command value Dapc1.

It should be noted that the control circuit 54 in the present embodiment comprises a control section. Further, the current driver 110 comprises a current supply section and the threshold current estimator 150 comprises an estimation section.

The differential efficiency adjustment section 300 adjusts the grayscale current command value Dapc2 using the emission amount L and the pixel data D, and transmits it to the current driver 110. Further, the differential efficiency adjustment section 300 adjusts a differential efficiency characteristic value of the semiconductor laser as more fully described below. The differential efficiency characteristic value is used when the threshold current estimator 150 estimates the threshold current Iₜₕ using the adjusted grayscale current command value Dapc2.

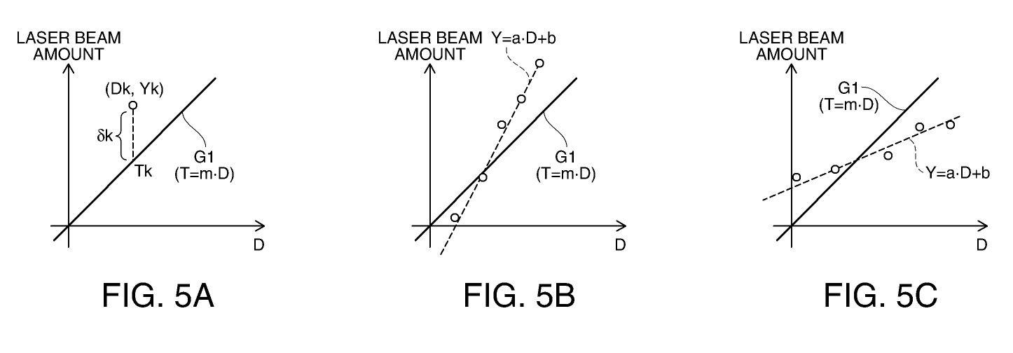

FIGS. 5A through 5C are explanatory diagrams for explaining the function of the differential efficiency adjustment section 300. FIG. 5A shows a graph representing a relationship between the pixel data D and the emission amount of the laser. Here, the target light amount T that the semiconductor laser 52 should emit in accordance with the pixel data D is represented as T=m·D which is shown as line G1 in the graph of FIG. 5A. In comparison, the actual measured emission amount Y measured by the light-sensitive element 130 and the I/V converter 140 is represented by the line Y=a·D+b. It should be noted that m is a coefficient, and a and b are variables. Further, the actual measured emission amount Y corresponds to the emission amount L which is emitted using the configuration shown in FIG. 1.

As previously described, semiconductor lasers typically have emission amounts which increases linearly in accordance with the current value supplied to the semiconductor lasers when the current supplied to the semiconductor lasers exceeds a threshold current. In the present specification, this characteristic is referred to as the “differential efficiency η.” It should be noted that it is known that the differential efficiency η varies in accordance with, for example, the temperature of the semiconductor laser.

As shown in FIG. 5A, the target light amount corresponding to certain pixel data Dₖ is Tₖ, and the actual measured emission amount is Yₖ. The difference between Yₖ and Tₖ can be represented as a light amount error δₖ. FIG. 5B shows the case where the characteristics of the laser vary so as to make the variable a of the actual measured emission amount Y larger, and FIG. 5C shows where the characteristics of the laser vary so as to make the variable a of the actual measured emission amount Y smaller. Since the variable a is a variable which affects to the differential efficiency η, it can be understood that it is desirable to correct the differential efficiency η in the both cases shown in FIGS. 5B and 5C. The differential efficiency adjustment section 300 sets the grayscale current command value Dapc2 so that the light amount error δₖ is minimized, thereby correcting the differential efficiency η. It should be noted that the variable b is a variable corresponding to the threshold current Iₜₕ, and the threshold current Iₜₕ is corrected by the threshold current estimator 150.

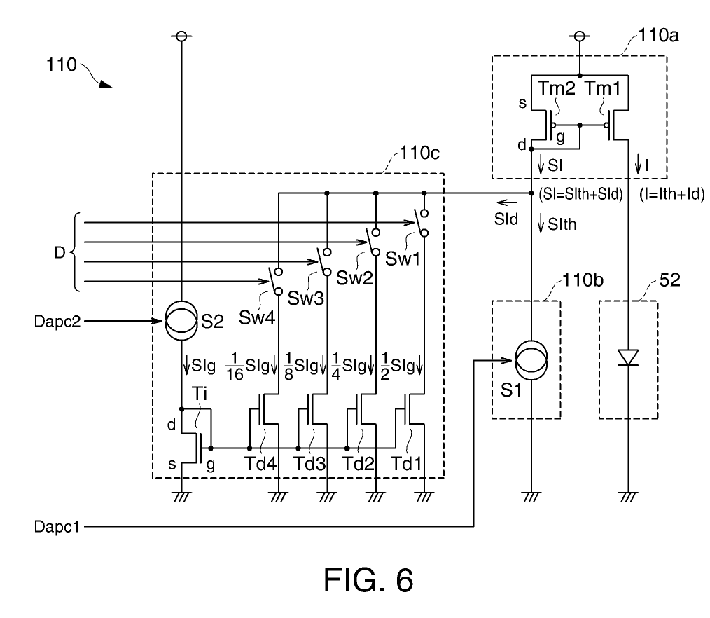

FIG. 6 is an explanatory diagram showing an internal configuration of the current driver 110 of FIG. 4. It should be noted that FIG. 6 also shows the semiconductor laser 52. The current driver 110 is provided with a drive current determination section 110a, a threshold current determination section 110b, and a light emission current determination section 110c.

As is well known in the art, the semiconductor laser 52 emits light when the drive current I exceeds the threshold current Iₜₕ. In other words, the emission amount L of the semiconductor laser 52 depends on the difference between the drive current I and the threshold current Iₜₕ. Therefore, in the present embodiment, the difference between the drive current I and the threshold current Iₜₕ is referred to as “a light emission current” I_{d}.

The drive current determination section 110a is provided with a current mirror circuit including two p-MOS transistors Tm1 and Tm2. The drain terminal of the first transistor Tm1 is connected to the semiconductor laser 52 and the drain terminal of the second transistor Tm2 is connected to the threshold current determination section 110b and the light emission current determination section 110c.

The threshold current determination section 110b is provided with a constant current source S1. The constant current source S1 is supplied with the threshold current command value Dapc1, and the constant current source S1 provides the current SIₜₕ corresponding to the threshold current command value Dapc1. It should be noted that the current SIₜₕ corresponds to the threshold current Iₜₕ.

The light emission current determination section 110c is provided with a constant current source S2 and an n-MOS transistor Tᵢ connected in series with each other. The constant current source S2 is supplied with the grayscale current command value Dapc2, and the constant current source S2 provides the current SI_{g} corresponding to the grayscale current command value Dapc2. It should be noted that in the present embodiment, since the grayscale current command value Dapc2 is a constant value, the current SI_{g} is constant.

Further, the light emission current determination section 110c is provided with four sets of switches Sw1-Sw4 and n-MOS transistors Td1-Td4 connected in parallel to each other. It should be noted that the switch (e.g., Sw1) and the transistor (e.g., Td1) of each of the sets are connected in series with each other. The four sets of switches Sw1-Sw4 and transistors Td1-Td4 are disposed in parallel to the threshold current determination section 110b. Further, the gate terminals of the four transistors Td1-Td4 are all connected to the gate terminal of the transistor Tᵢ.

The four switches Sw1-Sw4 are provided with the pixel data D composed of four bits. It should be noted that although the pixel data D is composed of four bits in FIG. 6, it is also possible to form the pixel data D with a fewer or larger number of bits. In such cases, it is sufficient to provide a number of sets of switches and transistors that corresponds to the number of bits of the pixel data D.

When each of the switches Sw1-Sw4 is set to the ON state in accordance with the pixel data D, the current flows through the corresponding transistor Td1-Td4. When the first switch Sw1 is set to be the ON state in accordance with the first bit or most significant bit of pixel data D, the current of ½·SI_{g} flows through the first transistor Td1. Similarly, when the second switch Sw2 is set to be the ON state in accordance with the second bit of the pixel data D, the current of ¼·SI_{g} flows through the second transistor Td2. When the third switch Sw3 is set to be the ON state in accordance with the third bit of the pixel data D, the current of ⅛·SI_{g} flows through the third transistor Td3. When the fourth switch Sw4 is set to be the ON state in accordance with the fourth bit or least significant bit of the pixel data D, the current of 1/16·SI_{g} flows through the fourth transistor Td4.

The current SId, which is the sum of the currents flowing through the four transistors Td1-Td4, is at the maximum ( 15/16·SI_{g}) when all of the switches Sw1-Sw4 are set to be the ON state. It should be noted that the current SId corresponds to the light emission current Id.

The current SI, which is the sum of the current SIₜₕ supplied to the threshold current determination section 110b and the current SI_{d} supplied to the light emission current determination section 110c, flows through the second transistor Tm2 of the drive current determination section 110a. In the present embodiment, since the two transistors Tm1 and Tm2 have the same size (channel length L/channel width W), a drive current I having the same value as the current SI flows through the first transistor Tm1. Further, the drive current I is supplied to the semiconductor laser 52. It should be noted that the sizes (L/W) of the two transistors Tm1 and Tm2 can also be different from each other.

As described above, the drive current I is determined using the current SIₜₕ corresponding to the threshold current Iₜₕ and the current SI_{d} corresponding to the light emission current Id. The current SIₜₕ corresponding to the threshold current Iₜₕ is determined in accordance with the threshold current command value Dapc1. The current SI_{d} corresponding to the light emission current Id is determined in accordance with the two signals Dapc2 and D.

By adopting the configuration shown in FIG. 6, the current driver 110 is capable of efficiently supplying the semiconductor laser 52 with the drive current I including the threshold current Iₜₕ and the light emission current I_{d} exceeding the threshold current Iₜₕ.

It should be noted that the threshold current determination section 110b comprises a first circuit and the light emission current determination section 110c comprises the second circuit in the claims recited below.

As explained with reference to FIGS. 4 and 6, the threshold current estimator 150 estimates the threshold current Iₜₕ using the drive current I and the emission amount L, and feeds-back the estimated threshold current Iₜₕ to the current driver 110 in real time. Further, the differential efficiency adjustment section 300 adjusts the grayscale current command value Dapc2 using the emission amount L and the pixel data D, and feeds it back to the threshold current estimator 150 and the current driver 110. Further, the current driver 110 determines the drive current I based on the pixel data D, the estimated threshold current Iₜₕ, and the adjusted grayscale current command value Dapc2. According to the present configuration, the semiconductor laser 52 can emit the laser beam with the emission amount L corresponding to the light emission current I_{d}.

It should be noted that it is sufficient for the operation band of the threshold current estimator 150 and the differential efficiency adjustment section 300 to correspond to a response speed which is higher than the temperature response of the semiconductor laser 52. For example, in the case in which the temperature response speed of the semiconductor laser 52 is several tens of microseconds, the operation band of the threshold current estimator 150 and the differential efficiency adjustment section 300 of several microseconds of several hundreds kHz is sufficient.

### A-4. OPERATION OF LIGHT SOURCE DEVICE

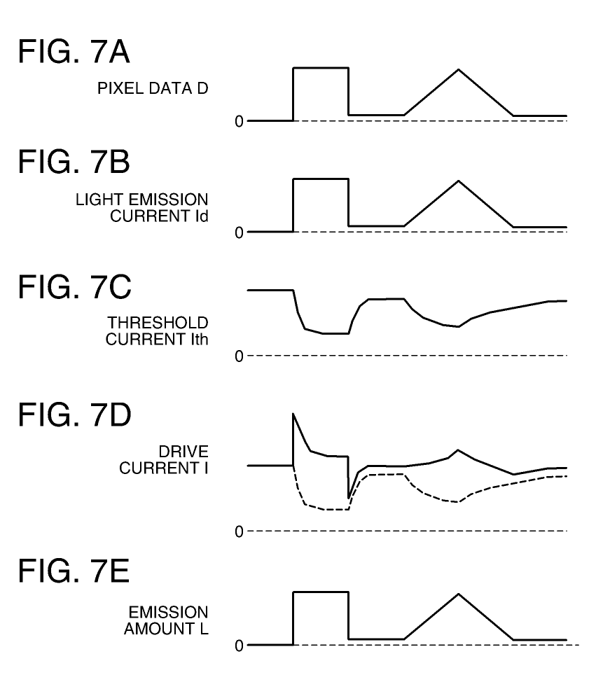

FIG. 7 is a timing chart showing an operation of the light source device 50 according to the present invention. FIG. 7A shows the pixel data D provided to the current driver 110. FIG. 7B shows the light emission current I_{d} corresponding to the pixel data D determined by the light emission current determination section 110c. FIG. 7C shows the threshold current Iₜₕ of the semiconductor laser 52 estimated by the threshold current estimator 150. FIG. 7D shows the drive current I supplied from the current driver 110 to the semiconductor laser 52. It should be noted that the threshold current Iₜₕ shown in FIG. 7C is also illustrated FIG. 7D as a dotted line. FIG. 7E shows the emission amount L of the semiconductor laser 52.

When the pixel data D varies as shown in the part FIG. 7A, the light emission current I_{d} varies in accordance with the pixel data D as shown in the FIG. 7B. As previously described, the threshold current Iₜₕ of the semiconductor laser 52 can vary in accordance with the temperature of the semiconductor laser. The threshold current Iₜₕ varies as, for example, shown in FIG. 7C. Since the drive current I is represented by the sum of the threshold current Iₜₕ (shown in FIG. 7C) and the light emission current I_{d} (shown in FIG. 7B), the semiconductor laser 52 is provided with the drive current I shown in FIG. 7D. As a result, the semiconductor laser 52 emits the light with the emission amount L shown in FIG. 7E.

As described above, since the drive current I, which is the sum of the threshold current Iₜₕ and the light emission current I_{d} corresponding to the pixel data D, is supplied to the semiconductor laser 52 in the present embodiment, it becomes possible to make the profile of the pixel data D (shown in FIG. 7A) and the profile of the emission amount L (shown in FIG. 7E) the same.

### A-5. THRESHOLD CURRENT ESTIMATOR

In order to configure the threshold current estimator 150, a method of operating a semiconductor laser 52 will now be described.

The rate equation of the semiconductor laser is represented by the following formulas (1), (2).

$$\begin{matrix}\frac{d N}{d t} = \frac{I}{e} \frac{1}{V} - \frac{N}{{τ}_{c}} - A ( N - {N}_{c} ) P & ( 1 ) \\ \frac{d P}{d t} = A ( N - {N}_{c} ) P - \frac{P}{{τ}_{p}} & ( 2 )\end{matrix}$$

Here, the symbol I denotes the current or drive current injected into the light emitting or active region, e denotes a charge, and V denotes the volume of the light emitting region. The symbol N denotes the density of the carriers injected into the light emitting region, and N_{c} denotes the carrier density for starting amplification of the light. The symbol N_{c} denotes the relaxation time or the time constant of losing the carrier density of the carriers. The symbol P denotes the energy density or photon number density of the laser beam. The symbol τₚ denotes the relaxation time or time constant at which the photon number density is lost. The symbol A denotes a coefficient related to the stimulated emission.

Formula (1) shows that the temporal variation of the number of carriers is obtained by subtracting the number of carriers lost by the relaxation and the number of the carriers contributing to the effective stimulated emission from the number of the carriers corresponding to the injected current. Formula (2) shows that the temporal variation of the number of photons is obtained by subtracting the number of photons lost by the relaxation from the number of the photons generated by the effective stimulated emission.

The photon number density P in the steady state is represented as the following formula (3) using the formulas (1), (2).

$$P = G ( I - {I}_{th} ) \\ {I}_{th} = \frac{e \cdot V}{{τ}_{c}} ( \frac{1}{A \cdot {τ}_{p}} + {N}_{c} ) \\ G = \frac{{τ}_{p}}{e \cdot V} \qquad ( 3 )$$

Next, the thermal lens effect of the semiconductor laser will be described. Assuming that the photon number density in the light emitting region increases due to the thermal lens effect, the rate equation is represented by the following formulas (4) and (5). It should be noted that formulas (4) and (5) are obtained by replacing the coefficient A related to the stimulated emission in formulas (2) and (3) with the coefficient A·F. Here, the coefficient F is a coefficient related to the effect of the thermal lens.

$$\begin{matrix}\frac{d N}{d t} = \frac{I}{e} \frac{1}{V} - \frac{N}{{τ}_{c}} - A ( N - {N}_{c} ) F \cdot P & ( 4 ) \\ \frac{d P}{d t} = A ( N - {N}_{c} ) F \cdot P - \frac{P}{{τ}_{p}} & ( 5 )\end{matrix}$$

Further, the photon number density P in the steady state is represented by the following formula (6). It should be noted that formula (6) is obtained by replacing the coefficient A in formula (3) with the coefficient A·F.

$$P = G ( I - {I}_{th} ) \\ {I}_{th} = \frac{e V}{{τ}_{c}} ( \frac{1}{A \cdot F \cdot {τ}_{p}} + {N}_{c} ) \\ G = \frac{{τ}_{ρ}}{e \cdot V} \qquad ( 6 )$$

Since the coefficient F is a coefficient related to the effect of the thermal lens, when the thermal lens effect becomes large in association with increase in the drive current I, the value of the coefficient F becomes large and the threshold current Iₜₕ becomes small. By contrast, when the thermal lens effect becomes small in association with decrease in the drive current I, the value of the coefficient F becomes small, and the threshold current Iₜₕ becomes large.

Incidentally, taking the proportion of the light emitted from the light emitting region and the sensitivities of the light-sensitive element 130 and the I/V converter 140 into consideration, the emission amount L of the semiconductor laser is represented by the following formula (7) using the coefficient M.

L=M(I−Iₜₕ) (7)

The response of the temperature of the light emitting region corresponding to the drive current I is represented by the following formula (8) assuming that a calorific value Q is proportional to the drive current I.

$$\begin{matrix}Q = a \cdot I \\ = C \frac{d 0}{d t} + k \cdot θ\end{matrix} \qquad ( 8 )$$

Here, the symbol a denotes a coefficient. Further, the symbol 0 denotes the temperature of the light emitting region, C denotes the calorific capacity of the light emitting region, and k denotes a heat conduction coefficient.

Assuming that τ [symbol] C/k is satisfied, the following formula (9) is obtained from formula (8).

$$τ \frac{d θ}{d t} + θ = \frac{a}{k} I \qquad ( 9 )$$

The threshold current Iₜₕ depends on the thermal lens effect (the coefficient F of formula (6)), and the thermal lens effect depends on the temperature of the light emitting region. Therefore, the threshold current Iₜₕ depends on the temperature of the light emitting region. Assuming that the threshold current Iₜₕ is a direct function of the temperature θ of the light emitting region, the following formula (10) is obtained. Note that p and q are constants.

θ=−p·Iₜₕ+q (10)

By substituting formula (10) for θ in formula (9), formula (11) is obtained. Note that α and β are constants.

$$\frac{d {I}_{th}}{d t} = \frac{- {I}_{th} + α - β I}{τ} \\ α = \frac{q}{p} \\ β = \frac{a}{p \cdot k} \qquad ( 11 )$$

The constants α and β are obtained by measuring the current-emission amount. Specifically, in the case in which the semiconductor laser 52 is provided with a direct current to emit light, the right side of formula (11) is equal to zero. Therefore, Iₜₕ=α−β·I is satisfied. Therefore, when the semiconductor laser 52 is made to emit light with the direct current, formula (12) is satisfied. Further, when the semiconductor laser 52 is made to emit light with an alternating current, more specifically, in the case in which the semiconductor laser is made to emit light with a shorter cycle time than the temperature response of the semiconductor laser 52, such as in a blink of light, formula (13) is satisfied.

$$\begin{matrix}\begin{matrix}{L}_{d c} = M \{ I - ( α - β I ) \} \\ = M \{ ( 1 + β ) I - α \} \\ = M ( 1 + β ) ( I - \frac{α}{1 + β} )\end{matrix} & ( 12 ) \\ {L}_{a c} = M ( I - {I}_{th} ) & ( 13 )\end{matrix}$$

By measuring of the current-emission amount with the direct current and the alternating current, the constants α, β can be obtained using formulas (12) and (13).

In the present embodiment, the threshold current estimator 150 is configured using an observer in modern control theory. From the result of the study using numerical calculation, it has been known that the accuracy of the parameter a described above has a significant influence on the estimation accuracy of the threshold current Iₜₕ. Therefore, in the present embodiment, the observer is configured as described below.

The threshold current Iₜₕ and the parameter α are selected as state variables. Further, the scaled state variables are hereinafter used so that the estimated values of the threshold current Iₜₕ can be fed-back directly to the current driver 110.

The output current I or drive current of the current driver 110 can be represented by formula (14) using the constants H1 and H2 (see FIG. 6). It is assumed that the scaled current values are u=I/H1, x=Iₜₕ/H1. In this case, formula (15) can be obtained from formula (14).

$$\begin{matrix}I = H 1 \cdot Dapc 1 + H 2 \cdot Dapc 2 \cdot D & ( 14 ) \\ u = Dapc 1 + \frac{H 2}{H 1} \cdot Dapc 2 \cdot D & ( 15 )\end{matrix}$$

Further, formula (16) is obtained from formula (7), and formula (17) is obtained from formula (11). Note that M1=M·H1, and α1=α/H1.

$$\begin{matrix}L = M \cdot H 1 ( \frac{I}{H 1} - \frac{{I}_{th}}{H 1} ) \\ = M 1 ( u - x )\end{matrix} \\ ∴ y = L = M 1 ( u - x ) \qquad ( 16 )$$

$$\frac{1}{H 1} \frac{d {I}_{th}}{d t} = \frac{- \frac{{I}_{th}}{H 1} + \frac{α}{H 1} - β \frac{I}{H 1}}{τ} \\ ∴ \frac{d x}{d t} = \frac{- x + α 1 - β u}{τ} \qquad ( 17 )$$

Assuming that the state variables are [x, α1]^{T}, the state equation of the plant can be represented by formula (18) using the formulas (16) and (17). It should be noted that the plant includes the semiconductor laser 52, the light-sensitive element 130, and the I/V converter 140, as shown in FIG. 4.

$$\dot{w} = A w + B u \\ y = C w + D u \\ w = [ \begin{matrix}x \\ α 1\end{matrix} ] \\ A = [ \begin{matrix}- \frac{1}{τ} & \frac{1}{τ} \\ 0 & 0\end{matrix} ] , B = [ \begin{matrix}- \frac{β}{τ} \\ 0\end{matrix} ] \\ C = [ \begin{matrix}- M 1 & 0\end{matrix} ] , D = M 1 \qquad ( 18 )$$

By configuring the observer, namely the threshold current estimator 150, using the state equation of formula (18), the threshold current Iₜₕ can be corrected. More specifically, the threshold current estimator 150 can be represented by formula (19).

$${w}^{\dot{\hat{}}} = A \hat{w} + B u - F ( y - \hat{y} ) \\ \hat{y} = C \hat{w} + D u \\ \hat{w} = [ \begin{matrix}\hat{x} \\ \hat{α} 1\end{matrix} ] \\ A = [ \begin{matrix}- \frac{1}{τ} & \frac{1}{τ} \\ 0 & 0\end{matrix} ] , B = [ \begin{matrix}- \frac{β}{τ} \\ 0\end{matrix} ] \\ C = [ \begin{matrix}- M 1 & 0\end{matrix} ] , D = M 1 \\ F = [ \begin{matrix}\frac{f}{τ} \\ \frac{{f}_{0}}{τ}\end{matrix} ] \qquad ( 19 )$$

Note that “̂” in the formula denotes an estimated value. The elements f/τ, f₀/τ are feed-back coefficients.

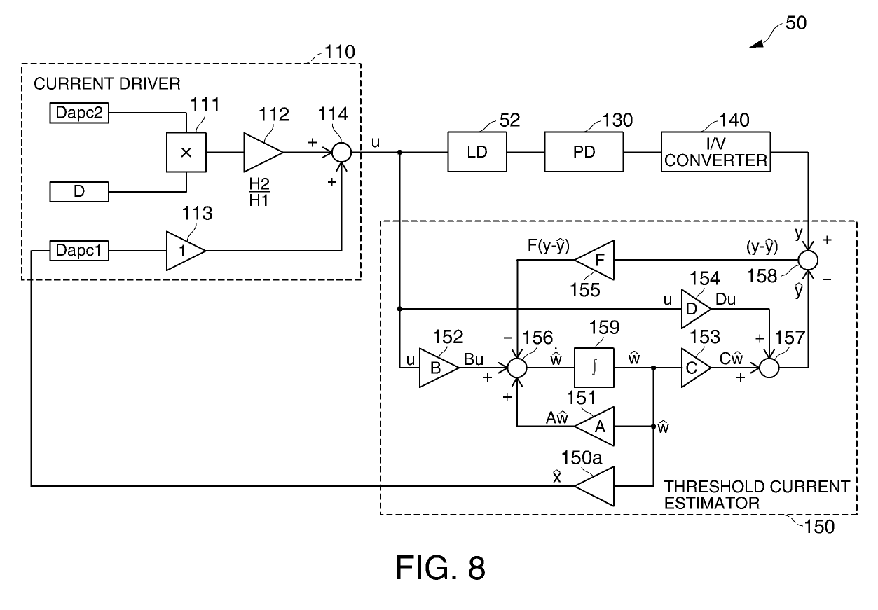

FIG. 8 is an explanatory diagram showing a specific configuration of the light source device 50. It should be noted that although FIG. 8 is obtained by redrawing FIG. 4 using formulas (15) and (19), the differential efficiency adjustment section 300 is omitted from the drawing for the sake of convenience. Specifically, the current driver 110 is represented by formula (15) and the threshold current estimator 150 is represented by formula (19).

The current driver 110 includes a multiplier 111, two amplifiers 112 and 113, and an adder 114. The multiplier 111 multiplies the threshold current command value Dapc2 by the pixel data D to output the signal Dapc2·D. The first amplifier 112 amplifies the signal Dapc2·D to be H2/H1 times as large to output the signal H2/H1·Dapc2·D. It should be noted that the grayscale current command value Dapc2 is adjusted by the differential efficiency adjustment section 300 described more fully below.

The second amplifier 113 amplifies the signal Dapc1 to be the same value. The adder 114 adds the two signals H2/H1·Dapc2·D and Dapc1 output respectively from the two amplifiers 112 and 113 together. As a result, the signal u represented by formula (15) is output form the adder 114.

It should be noted that the second amplifier 113, which is provided in the present embodiment can be eliminated.

The threshold current estimator 150 includes five amplifiers 151-155, three computing units 156-158, an integrator 159, and an extractor 150a

The integrator 159 integrates the signal d(ŵ)/dt to output the signal ŵ.

The first amplifier 151 amplifies the signal ŵ A times to output the signal A·ŵ. The second amplifier 152 amplifies the signal u B times to output the signal B·u. The third amplifier 153 amplifies the signal ŵ C times to output the signal C·ŵ. The fourth amplifier 154 amplifies the signal u D times to output the signal D·u. The fifth amplifier 155 amplifies the signal (y−ŷ) F times to output the signal F·(y−ŷ).

The first computing unit 156 adds the signals A·ŵ and B·u to each other, and subtracts the signal F·(y−ŷ) therefrom, thereby outputting the signal d(ŵ)/dt represented by formula (19). The second computing unit 157 adds the signals C·ŵ and D·u to each other to output the signal ŷ represented by formula (19). The third computing unit 158 subtracts the signal ŷ from the signal y to output the signal (y−ŷ). It should be noted that the signal y represents the measured value of the emission amount L, and the signal ŷ represents the estimated value of the emission amount L of formula (16).

The extractor 150a extracts the signal \hat{x} from the signal ŵ, and feeds-back the signal \hat{x} to the current driver 110 as the threshold current command value Dapc1.

By substituting the contents of the coefficients A-D and F for the coefficients A-D and F in the equations of formula (19), formula (20) can be obtained. Further, by developing formula (20), formula (21) can be obtained.

$$\begin{matrix}{w}^{\dot{\hat{}}} = [ \begin{matrix}{x}^{\dot{\hat{}}} \\ {α}^{\dot{\hat{}}} 1\end{matrix} ] = [ \begin{matrix}- \frac{1}{τ} & \frac{1}{τ} \\ 0 & 0\end{matrix} ] [ \begin{matrix}\hat{x} \\ \hat{α} 1\end{matrix} ] + [ \begin{matrix}- \frac{β}{τ} \\ 0\end{matrix} ] u - [ \begin{matrix}\frac{f}{τ} \\ \frac{{f}_{0}}{τ}\end{matrix} ] ( y - \hat{y} ) & ( 20 ) \\ \hat{y} = [ \begin{matrix}- M 1 & 0\end{matrix} ] [ \begin{matrix}\hat{x} \\ \hat{α} 1\end{matrix} ] + M 1 \cdot u \\ {x}^{\dot{\hat{}}} = \frac{1}{τ} ( \hat{α} 1 - \hat{x} ) - \frac{β}{τ} u - \frac{f}{τ} ( y - \hat{y} ) \\ {α}^{\dot{\hat{}}} 1 = - \frac{{f}_{0}}{τ} ( y - \hat{y} ) \\ \hat{y} = M 1 ( u - \hat{x} ) & ( 21 )\end{matrix}$$

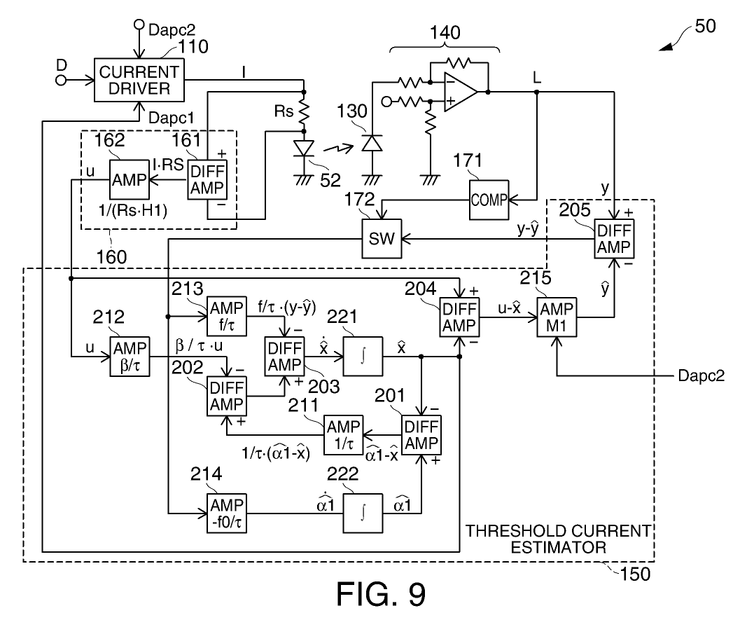

FIG. 9 is an explanatory diagram showing a circuit diagram of the light source device 50. It should be noted that although FIG. 9 is obtained by redrawing FIG. 4 using formula (21), the differential efficiency adjustment section 300 is omitted from the drawing for the sake of convenience.

As shown in the drawing, the light source device 50 is provided with a drive current measurement section 160 for measuring the drive current I (the signal u) supplied to the semiconductor laser 52. The drive current measurement section 160 is provided with a differential amplifier 161 and an amplifier 162. The two terminals of the differential amplifier 161 are connected to both ends of a resistor Rs connected to the anode of the semiconductor laser 52. The differential amplifier 161 receives the voltages of the both ends of the resistor Rs and outputs the difference in voltage between the both ends. It should be noted that the difference in voltage is represented by I·Rs. The amplifier 162 multiplies the difference in voltage 1/(Rs·H1) times. As a result, the multiplier 162 outputs the signal I/H1, namely the signal u.

The threshold current estimator 150 includes five differential amplifiers 201-205, five amplifiers 211-215, and two integrators 221 and 222.

The first integrator 221 integrates the signal d(\hat{x})/dt to output the signal \hat{x}. The second integrator 222 integrates the signal d(\hat{α}1)/dt to output the signal \hat{α}1.

The first differential amplifier 201 subtracts the signal \hat{x} from the signal \hat{α}1 to output the signal (\hat{α}1−\hat{x}). The first amplifier 211 amplifies the signal (\hat{α}1−\hat{x})1/τ times to output the signal 1/τ·(\hat{α}1−\hat{x}). The second amplifier 212 amplifies the signal u β/τ times to output the signal β/τ·u. The second differential amplifier 202 subtracts the signal β/τ·u from the signal 1/τ·(\hat{α}1−\hat{x}) to output the signal [1/τ·(\hat{α}1−\hat{x})−β/τ·u]. The third amplifier 213 amplifies the signal (y−ŷ)f/τ times to output the signal f/τ·(y−ŷ). The third differential amplifier 203 subtracts the signal f/τ·(y−ŷ) from the signal [1/τ·(\hat{α}1−−\hat{x})−β/τ·u] to output the signal d(\hat{x})/dt represented by formula (21).

The fourth amplifier 214 amplifies the signal (y−ŷ)−f₀/τ times to output the signal d(\hat{α}1)/dt represented by formula (21).

The fourth differential amplifier 204 subtracts the signal \hat{x} from the signal u to output the signal (u−\hat{x}). The fifth amplifier 215 amplifies the signal (u−\hat{x}) M1 times to output the signal ŷ represented by the formula (21). The value M1 represents the differential efficiency η of the semiconductor laser 52, and is hereinafter also referred to as “the differential efficiency characteristic value M1.” Specifically, the signal ŷ represents the estimated value of the emission amount of the semiconductor laser 52 obtained by the estimated value \hat{x}. It should be noted that the fifth amplifier 215 is formed of a variable gain amplifier the gain of which can arbitrarily be controlled, and the gain M1 is set in accordance with the grayscale current command value Dapc2 adjusted by the differential efficiency adjustment section 300 as described more fully below.

The fifth differential amplifier 205 subtracts the signal ŷ from the signal y to output the signal (y−ŷ).

As previously above, since the threshold current estimator 150 uses the two state variables x and α1, the threshold current estimator 150 is provided with the first integrator 221 for integrating the signal d(\hat{x})/dt, which is the derivative of the signal \hat{x}, in order to obtain the signal \hat{x}, and the second integrator 222 for integrating the signal d(\hat{α}1)/dt, which is the derivative of the signal \hat{α}1, to obtain the signal \hat{α}1. The threshold current estimator 150 obtains the signal ŷ using the signal u and the signal \hat{x} output from the first integrator 221. Further, the threshold current estimator 150 obtains the signal d(\hat{α}1)/dt to be provided to the second integrator 222 using the signal (y−ŷ). Further, the threshold current estimator 150 obtains the signal d(\hat{x})/dt to be provided to the first integrator 221 using the signal u, the signal (y−ŷ), the signal \hat{x} output from the first integrator 221, and the signal \hat{α}1 output from the second integrator 222.

As described above, by using the two state variables x, α1, the estimated value \hat{x} of the threshold current can accurately be obtained. Further, since the threshold current estimator 150 uses the differential efficiency characteristic value M1 corresponding to the grayscale current command value Dapc2 adjusted by the differential efficiency adjustment section 300, the variation in the characteristics of the semiconductor light emitting element is reflected in the estimated value, meaning that the estimation accuracy thereof can be improved.

The light source device 50 further includes a comparator 171 and a switch 172. The comparator 171 compares the signal y (the emission amount L) with zero If the signal y is equal to or greater than zero, the comparator 171 sets the switch 172 to be the ON state. On this occasion, the switch 172 transmits the output of the differential amplifier 205, namely the signal (y−ŷ). On the other hand, if the signal y is a negative value, the comparator 171 sets the switch 172 to be the OFF state. On this occasion, the switch 172 does not transmit the signal (y−ŷ) of the differential amplifier 205, and instead outputs the value of zero.

Since the signal (y−ŷ) is not accurate in the non-emission period of the semiconductor laser 52, it is not preferable to feed-back the signal (y−ŷ) to the two integrators 221 and 222 of the threshold current estimator 150. Therefore, in the non-emission period, the feed-back loop is cut using the comparator 171 and the switch 172. As a result, in the non-emission direction, the threshold current estimator 150 is only provided with the measurement value (u) of the drive current I. Further, the threshold current estimator 150 obtains the estimated value \hat{x} of the threshold current Iₜₕ in an open-loop manner.

As described above, since the feeding-back of the signal (y−ŷ) to the input of the threshold current estimator 150 is blocked in the non-emission period, the threshold current estimator 150 can obtain the estimated value \hat{x} of the threshold current in an open-loop manner.

Incidentally, when the non-emission period is long, an error in the estimated value (\hat{x}) of the threshold current, more specifically, the difference between the actual value (x) and the estimated value (\hat{x}) may gradually increase. However, when the semiconductor laser 52 starts emitting light again, the threshold current estimator 150 can output the correct estimated value (\hat{x}). It should be noted that a certain period of time (the recovery time) is required before the threshold current estimator 150 is able to output the correct estimated value (\hat{x}). Taking the recovery time into consideration, in the present embodiment, as shown in FIG. 2, an extra period T0 is provided immediately before an effective period Tb. It should be noted that the extra period T0 has a length equal to or greater than the recovery time. In the present embodiment, the control circuit 54 preliminarily supplies the current driver 110 with the drive current I in the extra period T0, thereby making the semiconductor laser 52 preliminarily emit light. Thus, the threshold current estimator 150 can output the correct estimated value (\hat{x}) in the entire period including the starting period of the effective period Tb. It should be noted that it is sufficient to mask the light emitted from the semiconductor laser 52 in the extra period T0 so that light is not emitted to the screen 70.

As described above, by making the semiconductor laser 52 preliminarily emit light immediately before making the semiconductor laser 52 start significant emission, it becomes possible to correctly obtain the estimated value \hat{x} of the threshold current immediately after the semiconductor laser 52 starts the significant emission.

As explained hereinabove, in the present embodiment, since the estimated value \hat{x} of the threshold current is obtained, and the drive current u is determined using the pixel data D and the estimated value \hat{x} of the threshold current is supplied to the semiconductor laser 52, it is possible to make the semiconductor laser 52 accurately emit light with an intensity that accurately corresponds to the pixel data D even when the actual threshold current varies due to temperature variation.

Incidentally, the threshold current estimator 150 described herein can also be configured as a digital circuit. Here, by converting formula (19) into the discrete-time system with the sampling interval Ts using the trapezoidal approximation, formula (22) corresponding to formula (20) can be obtained. Further, when developing formula (22), formula (23) corresponding to formula (21) can be obtained.

$${\hat{W}}_{k + 1} = [ \begin{matrix}1 - \frac{{T}_{s}}{{τ}_{obs}} & \frac{{T}_{s}}{{τ}_{obs}} \\ 0 & 1\end{matrix} ] {\hat{W}}_{k} + [ \begin{matrix}- \frac{β \cdot {T}_{s}}{{τ}_{obs}} \\ 0\end{matrix} ] {U}_{k} - [ \begin{matrix}\frac{f \cdot {T}_{s}}{{τ}_{obs}} \\ \frac{{f}_{0} \cdot {T}_{s}}{{τ}_{obs}}\end{matrix} ] ( {Y}_{k} - {\hat{Y}}_{k} ) \\ {\hat{Y}}_{k} = [ \begin{matrix}- M 1 & 0\end{matrix} ] {\hat{W}}_{k} + M 1 \cdot {U}_{k} \\ {\hat{W}}_{k} = [ \begin{matrix}{\hat{X}}_{k} \\ \hat{X} {0}_{k}\end{matrix} ] \qquad ( 22 )$$

It should be noted that dŵ/dt corresponds to Ŵₖ₊₁, and the ŵ corresponds to Ŵₖ. Further, y and ŷ correspond respectively to Yₖ and Ŷₖ, \hat{x} and \hat{α}1 correspond respectively to \hat{X}ₖ and \hat{X}Oₖ.

$$\begin{matrix}\begin{matrix}{\hat{X}}_{k + 1} = ( 1 - \frac{{T}_{s}}{{τ}_{obs}} ) {\hat{X}}_{k} + \frac{{T}_{s}}{{τ}_{obs}} \hat{X} {0}_{k} - \frac{β \cdot {T}_{s}}{{τ}_{obs}} {U}_{k} - \frac{f \cdot {T}_{s}}{{τ}_{obs}} ( {Y}_{k} - {\hat{Y}}_{k} ) \\ = {\hat{X}}_{k} + \frac{{T}_{s}}{{τ}_{obs}} ( \hat{X} {0}_{k} - {\hat{X}}_{k} - β \cdot {U}_{k} ) - \frac{f \cdot {T}_{s}}{{τ}_{obs}} ( {Y}_{k} - {\hat{Y}}_{k} )\end{matrix} & ( 23 ) \\ \hat{X} {0}_{k + 1} = \hat{X} {0}_{k} - \frac{{f}_{0} \cdot {T}_{s}}{{τ}_{obs}} ( {Y}_{k} - {\hat{Y}}_{k} ) & \\ {\hat{Y}}_{k} = M 1 ( {U}_{k} - {\hat{X}}_{k} ) & \end{matrix}$$

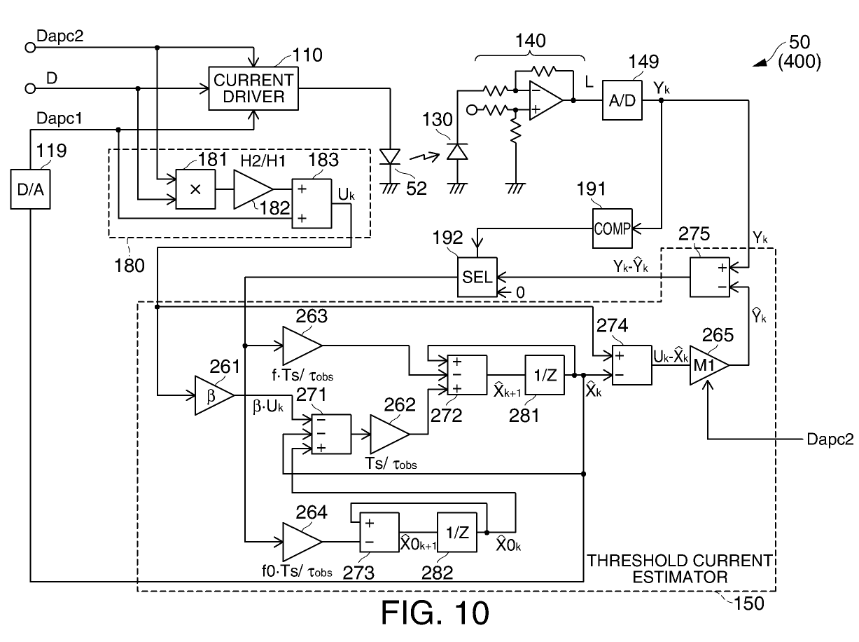

FIG. 10 corresponds to a drawing obtained by redrawing FIG. 4 using formula (23). FIG. 10 is roughly the same as FIG. 9 except the point that the threshold current estimator 150 is formed of a digital circuit, and a drive current calculation section 180 is provided instead of the drive current measurement section 160. It should be noted that other differences and relationship between FIGS. 9 and 10 will be explained as necessary.

The drive current calculation section 180 is provided with a multiplier 181, an amplifier 182, and an adder 183. The multiplier 181 multiplies the pixel data D by the grayscale current command value Dapc2 to output the signal Dapc2·D. The amplifier 182 amplifies the signal Dapc2·D to be H2/H1 times as large to output the signal H2/H1·Dapc2·D. The adder 183 adds the signal H2/H1·Dapc2·D and the signal Dapc1 together to output the signal (Dapc1+H2/H1·Dapc2·D), namely the signal Uₖ (as described in formula (15)). It should be noted that the signal Uₖ corresponds to the signal u shown in FIG. 9.

As is understood from the explanations described above, the threshold current estimator 150 shown in FIG. 9 estimates the threshold current Iₜₕ using the measured value (u) of the drive current I obtained by the drive current measurement section 160. In contrast, the threshold current estimator 150 shown in FIG. 10 estimates the threshold current Iₜₕ using the calculated value (Uₖ) of the drive current I obtained by the drive current calculation section 180.

The light source device 50 shown in FIG. 10 is further provided with a D/A converter 119 and an A/D converter 149. The D/A converter 119 executes the D/A (digital to analog) conversion on the signal \hat{X}ₖ to output the threshold current command value Dapc1. The A/D converter 149 executes the A/D (analog to digital) conversion on the signal L, which is output from the I/V converter 140, to output the signal Yₖ. It should be noted that, as described above, since the rate of the temperature response of the semiconductor laser is several tens of microseconds, it is sufficient to set the frequency of the sampling clock for the D/A converter 119, the A/D converter 149, and delay devices 281 and 282 which are described more fully below to be about 1 MHz.

The threshold current estimator 150 includes five amplifiers 261-265, five computing units 271-275, and two delay devices 281 and 282.

The first delay device 281 delays the signal \hat{X}ₖ₊₁ to output the signal \hat{X}ₖ. The second delay device 282 delays the signal \hat{X}0ₖ₊₁ to output the signal \hat{X}0ₖ.

The first amplifier 261 amplifies the signal Uₖ β times to output the signal β·Uₖ. The first computing unit 271 subtracts the signal \hat{X}ₖ and β·Uₖ from the signal \hat{X}0ₖ to output the signal (\hat{X}0ₖ−\hat{X}ₖ−β·Uₖ). The second amplifier 262 amplifies the signal (\hat{X}0ₖ−\hat{X}ₖ−β·Uₖ) Tₛ/τ_{obs} times as large to output the signal Tₛ/τ_{obs}·(\hat{X}0ₖ−\hat{X}ₖ−β·Uₖ).

The third amplifier 263 amplifies the signal (Yₖ−Ŷₖ) f·Tₛ/τ_{obs} times to output the signal f·Tₛ/τ_{obs}·(Yₖ−Ŷₖ). The second computing unit 272 adds the signal \hat{X}ₖ and the signal Tₛ/τ_{obs}·(\hat{X}0ₖ−\hat{X}ₖ−β·Uₖ) to each other, and subtracts the signal f·Tₛ/τ_{obs}·(Yₖ−Ŷₖ) therefrom. As a result, the second computing unit 272 outputs the signal \hat{X}ₖ₊₁ represented by formula (23).

The fourth amplifier 264 amplifies the signal (Yₖ−Ŷₖ)f₀·Tₛ/τ_{obs} times to output the signal f₀·Tₛ/τ_{obs}·(Yₖ−Ŷₖ). The third computing unit 273 subtracts the signal f₀·Tₛ/τ_{obs}·(Yₖ−Ŷₖ) from the signal \hat{X}0ₖ. As a result, the third computing unit 273 outputs the signal \hat{X}0ₖ₊₁ represented by formula (23).

The fourth computing unit 274 subtracts the signal \hat{X}ₖ from the signal Uₖ to output the signal (Uₖ−\hat{X}ₖ). The fifth amplifier 265 amplifies the signal (Uₖ−\hat{X}ₖ) M1 times to output the signal Yₖ represented by formula (23).

The fifth computing unit 275 subtracts the signal Ŷₖ from the signal Yₖ to output the signal (Yₖ−Ŷₖ).

Since the threshold current estimator 150 uses the two state variables X, X0, the threshold current estimator 150 is provided with the first delay device 281 for delaying the signal \hat{X}ₖ₊₁ at the time point k+1 to obtain the signal \hat{X}ₖ at the time point k, and the second delay device 282 for delaying the signal \hat{X}0ₖ₊₁ at the time point k+1 to obtain the signal \hat{X}0ₖ at the time point k. The threshold current estimator 150 obtains the signal Ŷₖ using the signals Uₖ and \hat{X}ₖ. Further, the threshold current estimator 150 obtains the signal \hat{X}0ₖ₊₁ provided to the second delay device 282 using the signal (Yₖ−Ŷₖ) and the signal \hat{X}0ₖ output from the second delay device 282. Further, the threshold current estimator 150 obtains the signal \hat{X}ₖ₊₁ to be provided to the first delay device 281 using the signal Uₖ, the signal (Yₖ−Ŷₖ), the signal \hat{X}ₖ output from the first delay device 281, and the signal \hat{X}0ₖ output from the second delay device 282.

As described above, by using the two state variables X, X0, the estimated value \hat{X}ₖ of the threshold current can accurately be obtained.

The light source device 50 is provided with a comparator 191 and a selector 192 instead of the comparator 171 and the switch 172 (FIG. 9). The comparator 191 compares the signal Ŷₖ with zero. When the signal Ŷₖ is equal to or greater than zero, the comparator 191 makes the selector 192 select the signal (Yₖ−Ŷₖ). On the other hand, when the signal Ŷₖ is a negative number, the comparator 191 makes the selector 192 select the value of zero.

According to the configuration described above, since the feed-back of the signal (Yₖ−Ŷₖ) to the input of the threshold current estimator 150 is inhibited in the non-emission period similar to the case explained with reference to FIG. 9, the threshold current estimator 150 can obtain the estimated value \hat{X}ₖ of the threshold current in an open-loop manner.

It should be noted that the comparator 191 and the selector 192 in the present embodiment comprise the inhibit section claims recited below.

Further, as explained with reference to FIG. 10, when the non-emission period is long, the error in the estimated value (\hat{X}ₖ) of the threshold current increases gradually. However, when the semiconductor laser 52 starts emitting light again, the threshold current estimator 150 can output the correct estimated value (\hat{X}ₖ). It should be noted that a certain recovery time is required before the threshold current estimator 150 outputs the correct estimated value (\hat{X}ₖ). Taking the recovery time into consideration, also in the light source device 50 shown in FIG. 10, the semiconductor laser 52 is made to emit light preliminarily in the extra period T0 immediately before the effective period T_{b} as shown in FIG. 2. As described above, by making the semiconductor laser 52 preliminarily emit light immediately before the semiconductor laser 52 starts a significant emission, it becomes possible to correctly obtain the estimated value \hat{x} of the threshold current immediately after the semiconductor laser 52 starts the significant emission.

### A-6. DIFFERENTIAL EFFICIENCY ADJUSTMENT SECTION

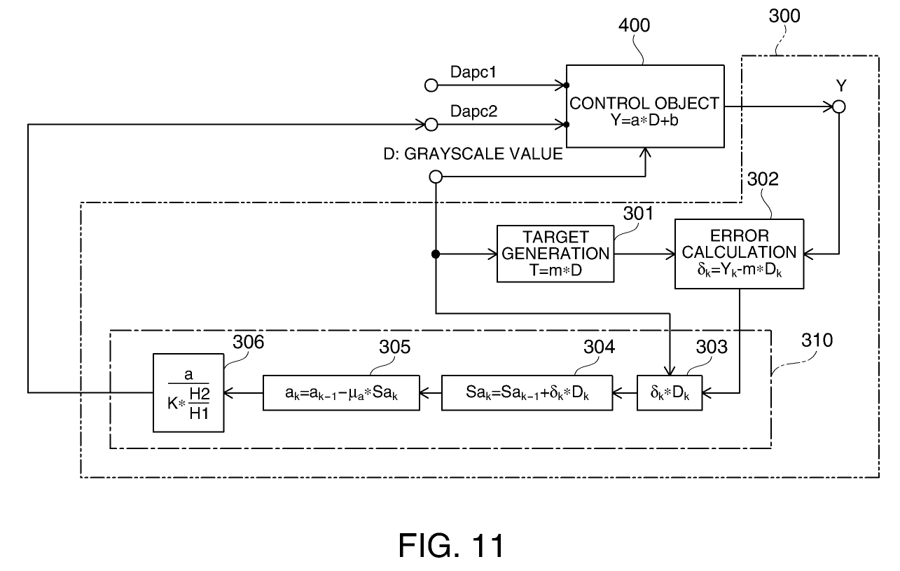

FIG. 11 is a schematic block diagram showing the configuration of the differential efficiency adjustment section 300. As explained with reference to FIGS. 5A-5C, the differential efficiency adjustment section 300 sets the grayscale current command value Dapc2 after adjusting the grayscale current command value Dapc2, and in order to execute such an operation, the differential efficiency adjustment section 300 measures a light amount error δ(Y−T), or difference between the target light amount T corresponding to the pixel data D and the actual measured emission amount Y It should be noted that if the number of times of the measurement is few (e.g., only two or three times), there may be errors in the setting value due to measurement error, and therefore, it is preferable to increase the number of times that the measurement is performed in order to successively improve the measurement accuracy. In the present embodiment, a least-square method using a steepest descent method capable of successively and most quickly searching the minimum value of the sum of squares of the light amount errors δ is used.

Here, the procedure of setting the pixel data (also referred to as “grayscale values”) D and measuring the actual measured emission amount Y is repeated k times. In this case, it is assumed that the actual measured emission amounts corresponding to the grayscale values {D₁, D₂, . . . , Dᵢ, . . . , Dₖ} are {Y₁, Y₂, . . . , Yᵢ, . . . , Yₖ}, and the target light amounts corresponding thereto are {T₁, T₂, . . . , Tᵢ, . . . , Tₖ}, respectively. The evaluation function εk is represented as the sum of squares of the light amount errors as shown in the formula (24) below, and the variable minimizing the evaluation function εk is successively obtained with respect to each value of i.

$${ɛ}_{k} = {\sum }_{i = 1}^{k} {( {Y}_{i} - {T}_{i} )}^{2} \qquad ( 24 )$$

By obtaining the gradient corresponding to the variation of the variable a, and using the steepest descent method for correcting a in the direction of the gradient, aₖ can be represented by the following formula (25). It should be noted that in the formula (25), μₐ is a coefficient.

$${a}_{k} = {a}_{k - 1} - \frac{{μ}_{a}}{2} * \frac{\partial {ɛ}_{k}}{\partial a} \qquad ( 25 )$$

By assuming that δᵢ=Yᵢ−Tᵢ is provided in the formula (24), ∂εₖ/∂a is represented by the following formula (26).

$$\begin{matrix}\frac{\partial {ɛ}_{k}}{\partial a} = \frac{\partial }{\partial a} \{ {\sum }_{i = 1}^{k} {( {Y}_{i} - {T}_{i} )}^{2} \} \\ = \frac{\partial }{\partial a} \{ {\sum }_{i = 1}^{k} {( a * {D}_{i} + b - {T}_{i} )}^{2} \} \\ = 2 * {\sum }_{i = 1}^{k} ( a * {D}_{i} + b - {T}_{i} ) * {D}_{i} \\ = 2 * {\sum }_{i = 1}^{k} ( {Y}_{i} - {T}_{i} ) * {D}_{i} \\ = 2 * {\sum }_{i = 1}^{k} {δ}_{i} * {D}_{i}\end{matrix} \qquad ( 26 )$$

Therefore, the following formula (27) is derived from formulas (25) and (26) described above, and by further modifying the formula so as to allow successive calculation, the formulas (28) through (30) described below can be obtained

$$\begin{matrix}{a}_{k} = {a}_{k - 1} - {μ}_{a} * {\sum }_{i = 1}^{k} {δ}_{i} * {D}_{i} & ( 27 ) \\ {δ}_{k} = {Y}_{k} - M * {D}_{k} & ( 28 ) \\ {a}_{k} = {a}_{k - 1} - {μ}_{a} * S {a}_{k} & ( 29 ) \\ S {a}_{k} = S {a}_{k - 1} + {δ}_{k} * {D}_{k} & ( 30 )\end{matrix}$$

Since the variable a is a variable corresponding to the differential efficiency η, it is understood that the differential efficiency η can sufficiently be corrected using the integration value of the products of the light amount error δₖ and the grayscale value Dₖ as shown in formula (30).

Here, the following formula (31) is obtained from the relationship between the drive current I, the threshold current command value Dapc1, and the grayscale current command value Dapc2, and the relationship between the emission amount L of the semiconductor laser 52, the drive current I, and the threshold current Iₜₕ (see formulas (15) and (16)).

$$\begin{matrix}L = Y = a * D + b \\ = K * ( \frac{H 2}{H 1} * D apc 2 * D + D apc 1 - \frac{{I}_{th}}{H 1} )\end{matrix} \qquad ( 31 )$$

Note that K is a coefficient.

Further, from the definition of Y=a·D+b, the variable a is represented by the following formula (32), and the grayscale current command value Dapc2 is represented by the formula (33).

$$\begin{matrix}a = K * \frac{H 2}{H 1} * D apc 2 & ( 32 ) \\ D apc 2 = \frac{a \cdot H 1}{K \cdot H 2} & ( 33 )\end{matrix}$$

By configuring the differential efficiency adjustment section 300 along formulas (28) through (33), the configuration shown in FIG. 11 may be obtained. The differential efficiency adjustment section 300 is provided with a target generation section 301, an error calculation section 302, and a calculation section 310. It should be noted that the control object 400 is a component (such as the current driver 110, the semiconductor laser 52, the light-sensitive element 130, the I/V converter 140, or the threshold current estimator 150) other than the differential efficiency adjustment section 300 in the light source device 50 shown in FIG. 10. In other words, the control object 400 outputs the actual measured emission amount value Y in accordance with the threshold current command value Dapc1, the grayscale current command value Dapc2, and the grayscale value D.

The error calculation section 302 outputs the difference between the target emission amount T(m*D) corresponding to the grayscale value D and supplied from the target generation section 301 and the actual measured emission amount value Y as an output value from the control object 400 to the calculation section 310. The calculation section 310 is provided with a moment calculation section 303, a moment integration section 304, a differential efficiency calculation section 305, and a grayscale command value calculation section 306. The moment calculation section 303 multiplies the light amount error δₖ output from the error calculation section 302 by the grayscale value Dₖ(δₖ*Dₖ). The moment integration section 304 integrates the value output by the moment calculation section 303 (as described in formula (30)). The differential efficiency calculation section 305 calculates the variable a using the integration value output by the moment integration section 304 (as described in formula (29)). The grayscale command value calculation section 306 calculates the grayscale current command value Dapc2 from the variable a (as described in formula (33)), and feeds it back to the control object 400.

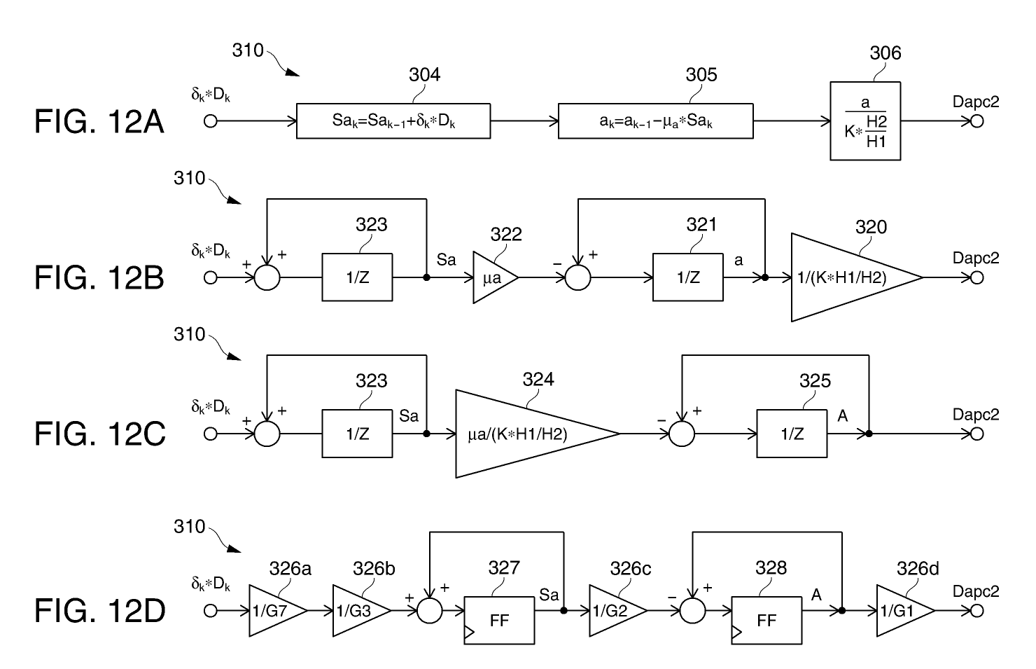

FIG. 12A is a schematic diagram showing a part of the calculation section 310, where the moment calculation section 303 is omitted. The calculation section 310 shown in FIG. 12A can be expressed as the block diagram shown in FIG. 12B using first and second delay elements 321 and 323. It is understood from the diagram that the operation between the input and the output do not vary even if a gain element 320 is moved to form a gain element 324 by integrating the gain elements 320 and 322 as shown in FIG. 12C. This operation corresponds to modifying of formula (29) described above into the following formula (34), and further replacing of the variable in formula (35) to rewrite it into formula (36). It should be noted that in FIG. 12C, the first delay element 321 shown in FIG. 12B is replaced with the third delay element 325.

$$\begin{matrix}\frac{{a}_{k}}{( K * H 2 / H 1 )} = \frac{{a}_{k - 1}}{( K * H 2 / H 1} - \frac{{μ}_{a}}{( K * H 2 / H 1 )} * S {a}_{k} & ( 34 ) \\ {A}_{k} = \frac{{a}_{k}}{( K * H 2 / H 1 )} & ( 35 ) \\ {A}_{k} = {A}_{k - 1} - \frac{{μ}_{a}}{( K * H 2 / H 1 )} * S {a}_{k} & ( 36 )\end{matrix}$$

By inserting gain elements into corresponding sections of the circuit shown in FIG. 12C, and further replacing the second and third delay elements 323 and 325 with first and second flip-flops 327 and 328, the diagram shown in FIG. 12D can be obtained. Here, the gain elements 326a-326d are used for the gain adjustment in the circuit. If each gain satisfies the following formula (37), the block diagrams shown in FIGS. 12C and 12D operate in an equivalent manner.

$$\frac{{μ}_{a}}{K \cdot \frac{H 2}{H 1}} = \frac{1}{G 7} \cdot \frac{1}{G 1} \cdot \frac{1}{G 2} \cdot \frac{1}{G 3} \qquad ( 37 )$$

It should be noted that although the output of the flip-flop 327 is a variable obtained by scaling Saₖ, and the output of the flip-flop 328 is a variable obtained by scaling aₖ, they might be referred to collectively as Saₖ in the explanations below in order to avoid complexity.

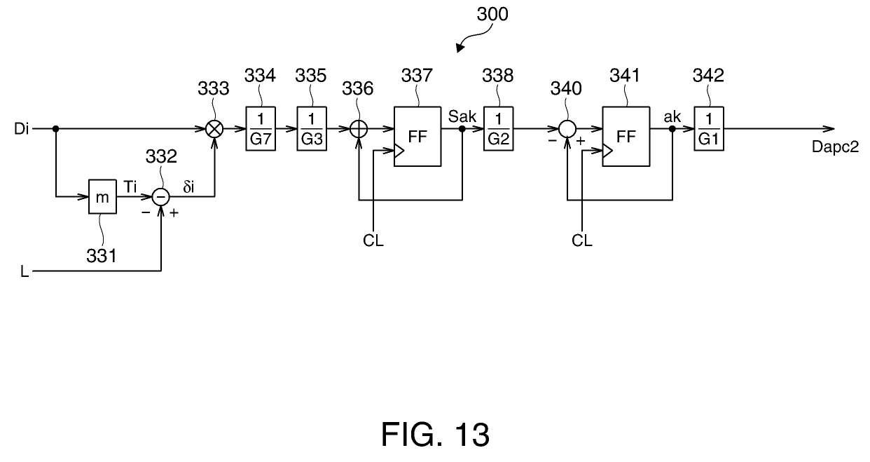

On the premise of the principle of the light amount correction in the present embodiment described above, a detailed configuration of the differential efficiency adjustment section 300 will hereinafter be explained with reference to FIG. 13. As shown in FIG. 13, the differential efficiency adjustment section 300 is composed of an m-multiplier 331, a subtracter 332, a multiplier 333, a G7-divider 334, a G3-divider 335, an adder 336, a flip-flop 337, a G2-divider 338, a subtracter 340, a flip-flop 341, and a G1-divider 342.

The m-multiplier 331 outputs the product of grayscale value Dᵢ represented by the grayscale data DR, DG, and DB of the respective colors and the coefficient m, to the subtracter 332 as the target light amount Tᵢ(m·Dᵢ). The subtracter 332 outputs the light amount error δᵢ(=Yᵢ−Tᵢ) obtained by subtracting the target light amount Ti from the light amount measurement value Yᵢ from the multiplier 333 and the G6-divider 334.

The multiplier 333 outputs the product (hereinafter referred to as a moment MTᵢ) of the grayscale value Dᵢ and the light amount error δᵢ to the G7-divider 334. The G7-divider 334 outputs the value obtained by dividing the moment MTᵢ by the coefficient G7 to the G3-divider 335. The G3-divider 335 outputs the value obtained by dividing the output value (MTᵢ/G7) of the G7-divider 334 by the coefficient G3 to the adder 336.

The adder 336 outputs an additional value obtained by adding the output value (MTᵢ/(G7·G3)) of the G3-divider 335 and the output value of the flip-flop 337 to the D-input terminal of the flip-flop 337. The flip-flop 337 is a D-type flip-flop, and reflects the input value on the D-input terminal as the output value in sync with a pixel sync clock signal CL. In other words, the adder 336 and the flip-flop 337 form the integration circuit for the moment MTᵢ(δᵢ·Dᵢ), and the output value of the flip-flop 337 becomes the integration value of the moment MTᵢ. Hereinafter, the integration value of the moment MTᵢ is referred to as Saₖ. It should be noted that the following is assumed:

Saₖ=δ₁·D₁+ . . . +δᵢ·Dᵢ+ . . . +δₖ·Dₖ

The G2-divider 338 outputs the value obtained by dividing the integration value Saₖ of the moment MTᵢ by the coefficient G2 to the subtracter 340. The subtracter 340 outputs the value obtained by subtracting the output value (Saₖ/G2) of the G2-divider 338 from the output value of the flip-flop 341, to the D-input terminal of the flip-flop 341. The flip-flop 341 is a D-type flip-flop, and reflects the input value on the D-input terminal as the output value in sync with a pixel sync clock signal CL. In other words, the subtracter 340 and the flip-flop 341 form the correction circuit for calculating the value aₖ=aₖ₋₁−μₐ·Saₖ represented by formula (29), and the output value of the flip-flop 341 becomes aₖ.

The G1-divider 342 outputs the value obtained by dividing the output value aₖ of the flip-flop 341 by the coefficient G1 as the grayscale current command value Dapc2. The grayscale current command value Dapc2 is supplied to the current driver 110 and the threshold current estimator 150, shown in FIG. 10. The threshold current estimator 150 controls the gain M1 of the fifth amplifier 265 based on the grayscale current command value Dapc2. This is because the gain M1 and the grayscale current command value Dapc2 have the relationship as described below.

Here, it is assumed that the threshold estimation is appropriately executed, meaning that the estimated value \hat{x} and the threshold current command value Dapc1 are equal to each other. According to the assumption, the following formula (38) can be obtained from formulas (15) and (16).

$$M 1 = \frac{Y}{\frac{H 2}{H 1} * D apc 2 * D} \qquad ( 38 )$$

In other words, it is preferable that the gain M1 is set having an inversely proportional relationship with the grayscale current command value Dapc2. More specifically, it is preferable to set the gain M1 so as to satisfy the following formula (39) in order to set the emission amount Y to be 510 when the pixel data D takes the maximum value of 255 in the present embodiment.

$$M 1 = \frac{510}{\frac{H 2}{H 1} * D apc 2 * 255} \qquad ( 39 )$$

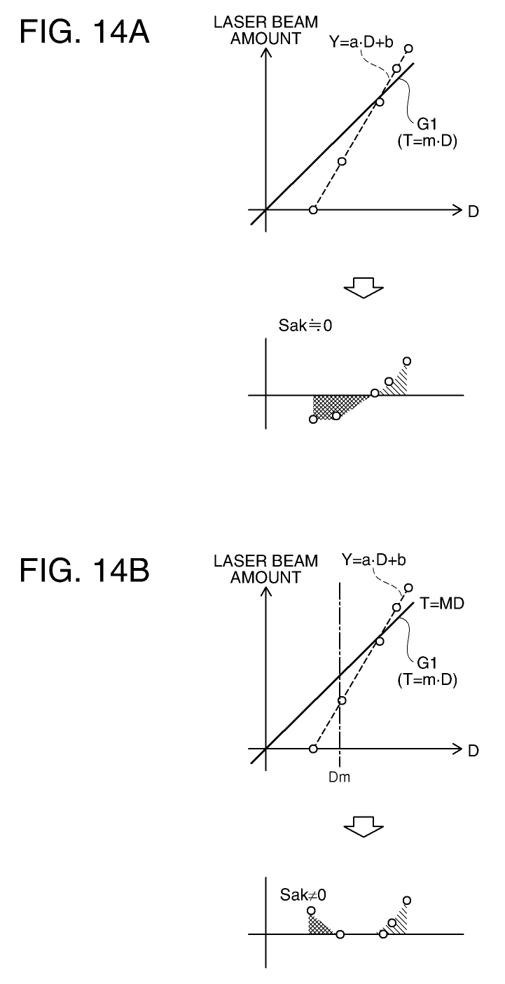

Incidentally, when the shift in the actual measured emission amount Y with respect to the target light amount T is as shown in FIG. 14A, there is a possibility that the integration value Saₖ of the products (the moment MTᵢ) of the light amount error δᵢ and the grayscale value Dᵢ approach zero, which substantially stops the adjustment function of the differential efficiency by the differential efficiency adjustment section 300. In this case, it is preferable to use a difference value (D−Dₘ) calculated by subtracting an intermediate value Dₘ in a range from the minimum grayscale value Dₘᵢₙ to the maximum grayscale value Dₘₐₓ from the input value D, in obtaining the moment. Thus, it becomes possible to prevent the integration value Saₖ of the moment MTᵢ from approaching zero.

Further, by successively calculating the average value Dₐᵥₑ of the grayscale values, and using a difference value (D−Dₐᵥₑ) calculated by subtracting the average value Dₐᵥₑ from the input value D as a calculation-use grayscale value used in obtaining the moment, it is also possible to prevent the integration value Saₖ of the products (moment values) of the light amount error and the grayscale value from approaching zero, similar to the case described above. In the explanation of this operation using a formula, the integration value of the products of the difference between the grayscale value Dₖ and the grayscale average value Dₐᵥₑ and the light amount error is calculated using the following formula (40) instead of formula (30).

Saₖ=Saₖ₋₁+δₖ*(Dₖ−Dₐᵥₑ) (40)

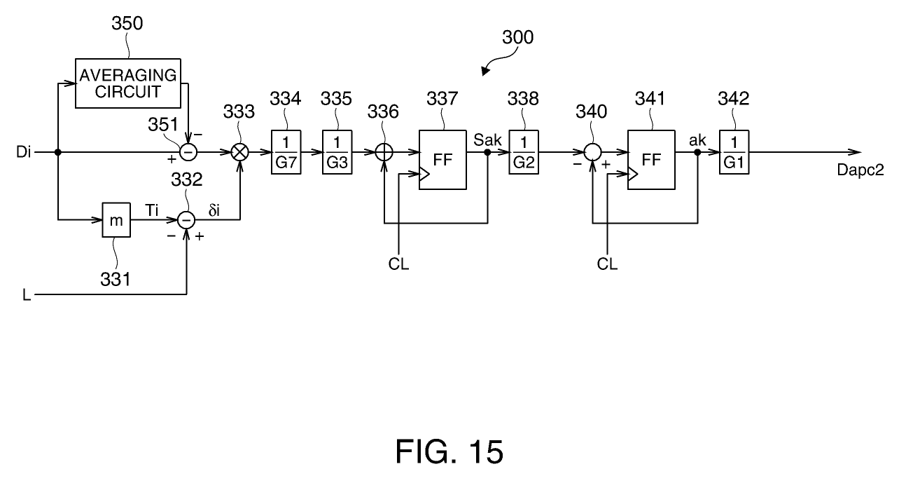

In this case, the differential efficiency adjustment section 300 can be configured as shown in FIG. 15. FIG. 15 is substantially the same as FIG. 13 except that an averaging circuit 350 for successively calculating the average value of the grayscale values Dᵢ and a subtracter 351 for subtracting the output value (the grayscale average value) of the averaging circuit 350 from the grayscale value are disposed on the anterior stage of the multiplier 333. It should be noted that as the value subtracted from the input value D in obtaining the calculation-use grayscale value, not only the average value of the grayscale value, but also a preset value, for example, a grayscale value of “128” in the case in which the 8-bit grayscale expression is used, may also be used in obtaining the moment.

As described above, since the gain M1 of the fifth multiplier 215 (FIG. 9) is controlled by the grayscale current command value Dapc2, the accuracy of the estimation result by the threshold current estimator 150 is improved. As previously described, the threshold current estimator 150 and the differential efficiency adjustment section 300 control the drive current I that is supplied to the semiconductor laser 52 by the current driver 110. Therefore, as in the case where the real threshold current vary due to the temperature variation, it is possible to make the semiconductor laser 52 accurately emit the light with an intensity which corresponds to the pixel data D.

### B. MODIFIED EXAMPLES

It should be noted that the invention is not limited to the specific examples and the embodiments described above may be modified in various ways without departing from the scope or the spirit of the invention. For example, following modifications may be used in association with the claimed invention.

### B1. Modified Example 1

In the embodiments described above, the differential efficiency adjustment section 300 executes the adjustment of the grayscale current command value Dapc2, namely the differential efficiency η, based on the emission amount of the semiconductor laser 52 as actually measured and the pixel data D. It is also possible, however, to arrange that the adjustment of the differential efficiency η using another measurement value. For example, since the differential efficiency η is lowered in accordance with the rise temperature of the semiconductor laser, the control section can also be arranged to execute control so that the current output by the current driver increases in accordance with the temperature of the semiconductor laser. More specifically, it is also possible to arrange that the temperature of the semiconductor laser 52 is measured, and the differential efficiency adjustment section 300 determines the suitable grayscale current command value Dapc2 corresponding to the measured temperature using a series of predetermined series of values or the like.

### B2. Modified Example 2

Although in the embodiments, the threshold current estimator 150 comprises an observer, it is also possible to arrange that the threshold current estimator 150 estimates the threshold current using other methods. For example, it can be arranged to estimate the threshold current based on the relationship between the actual measured emission amount of the semiconductor laser 52 with respect to the drive current and the differential efficiency calculated by the differential efficiency adjustment section 300.

### B3. Modified Example 3

In the embodiments described above, for the sake of convenience of explanation, the projector PJ (FIG. 1) is provided with only one light source device 50. However, the projector may also be provided with, for example, three light source devices for emitting three kinds of colored light beams and a combining optical system for combining the three kinds of colored light beams. Further, the combined light beam may be guided to the polygon mirror 62. As a result, a color image is displayed on the screen 70.

### B4. Modified Example 4

In the embodiments described above, the projector PJ is provided with the polygon mirror 62, and each of the line images included in the image displayed on the screen 70 in one direction. However, an alternate configuration may be used, wherein adjacent line images displayed on the screen 70 are displayed in alternating directions. It should be noted that such a projector is disclosed in, for example, Japanese Patent Publication No. JP-A-2006-227144. Also in this case, it is preferable to provide the extra period in which the preliminary emission of light is executed, immediately before each of the line images is drawn.

### B5. Modified Example 5

Although in the embodiments described above, the light amount correction process is executed during the display operations, there is a possibility that the normal light amount correction may not be achieved if the grayscale value is biased, such as, for example, when an extremely dark image is included in the display. As a counter measure to the case described above, it is possible to arrange that a predetermined grayscale (grayscale data) or a pseudo pixel sync clock signal is generated in the period in which no image display is executed, thereby making the semiconductor laser emit light to execute the light amount correction operation.

### B6. Modified Example 6

When calculating the integration value Saₖ of the moment MTᵢ in the embodiments described above, since it is preferable to give greater importance to the more recent data (the value of the product of the light amount error and the grayscale value), it is possible to put lower weight on the data further in the past. Specifically, it is sufficient to dispose a weighing constant multiplier in the feed-back path from the output terminal of the flip-flop 337 to the adder 336 shown in FIG. 13. The weighing constant is set to be a value smaller than 1 such as ⅞. Thus, the impact of data in the past is sequentially decreased when calculating the integration value Saₖ, and therefore, it becomes possible to give weight to the most recent data. Further, although in the embodiments described above, the variable a is successively corrected with the value proportional to the integration value Saₖ of the products (moment values) of the light amount error and the grayscale value, it is also possible to execute a correction of a constant value of the variable a in accordance with the sign of the integration value Saₖ.

### B7. Modified Example 7

Although in the embodiments described above, the light source device according to the invention is applied to the so-called raster scan type projector, the light source device may also be used in a projector provided with a light modulation device such as a liquid crystal panel or DMD (Digital Micromirror Device, a trademark of Texas Instruments). In this case, it is sufficient to provide a constant value as the signal D, for example.

Further, although in the embodiments descried above, the invention is applied to the projection type image display device, the invention can also be applied to a direct view type image display device.

### B8. Modified Example 8

Although in the embodiments described above, the light source device 50 is applied to the projector PJ, the light source devices can also be applied to other optical devices such as processing equipment instead of the projector PJ.

### B9. Modified Example 9

Although the light source device 50 is provided with the semiconductor laser in the embodiments described above, it is also possible to provide the light source device with another solid-state light source (semiconductor light emitting element) such as a light emitting diode (LED) instead of the semiconductor laser.

### B10. Modified Example 10

In the embodiments described above, it is possible to replace a part of the configuration realized by hardware with software, or to replace a part of the configuration realized by software with hardware.

What is claimed is:

1. A light source device comprising:
a semiconductor light emitting element; and
a control section adapted to control the semiconductor light emitting element in accordance with an input value,
wherein the control section includes
a characteristic value calculation section adapted to calculate a characteristic value representing an input-output characteristic of the semiconductor light emitting element in accordance with a measured value related to the semiconductor light emitting element,
a current supply section adapted to supply the semiconductor light emitting element with a drive current based on the characteristic value, the input value, and an estimation value of a threshold current of the semiconductor light emitting element, and
an estimation section adapted to obtain the estimation value of the threshold current used by the current supply section using a value of the drive current, a light amount detection value related to an amount of light emitted from the semiconductor light emitting element, and the characteristic value.

2. The light source device according to claim 1, wherein
the characteristic value is a differential efficiency defined by an amount of variation in the light amount detection value with respect to an amount of variation in the drive current, and
the characteristic value calculation section
calculates a light amount error corresponding to the difference between a target light amount to be output from the semiconductor light emitting element in accordance with the input value, and the light amount detection value, and
calculates the differential efficiency using an integration value of a product of the light amount error and the input value.

3. The light source device according to claim 2, wherein
the current supply section includes
a first circuit capable of determining the threshold current included in the drive current using the estimation value of the threshold current, and
a second circuit capable of determining a surplus current using a current value corresponding to a current command signal output from the characteristic value calculation section and the input value, and
the characteristic value calculation section
determines a present value of a first variable corresponding to the differential efficiency by subtracting a numerical value which is proportional to an integration value of the product of the light amount error and the input value from a previous value of the first variable determined by the characteristic value calculation section, and
outputs a current command signal corresponding to the present value of the first variable to the current supply section.

4. The light source device according to claim 2, wherein the characteristic value calculation section uses one of a difference between an average value of the input values and the input value, a difference between an initial setting input value set previously and the input value, and a difference between an intermediate value in a range from the minimum input value to the maximum input value and the input value as a calculation input value used when calculating the integration value of the product of the light amount error and the input value.

5. The light source device according to claim 2, wherein the characteristic value calculation section performs a weighting operation to obtain the integration value of the product of the light amount error and the input value by multiplying the light amount error with a weighing constant so that a more recent light amount error is given a higher weight in the integration value than a less recent light amount error.

6. The light source device according to claim 2, wherein the estimation section comprises a observer which is capable of:
determining an estimation value of the threshold current as an estimation value of a first state variable,
multiplying the difference between the drive current and the estimation value of the threshold current by a value corresponding to the differential efficiency, thereby obtaining an estimated emission amount of the semiconductor light emitting element, and
determining an estimation value of the threshold current using the estimated emission amount.

7. The light source device according to claim 6, wherein the estimation section is further capable of determining an estimation value of a second state variable corresponding to an amount of a constant term of a first order differential equation representing a variation in the threshold current.

8. The light source device according to claim 1, wherein the estimation section is further capable of:
determining an estimation value related to an amount of light emitted from the semiconductor light emitting element using a value of the drive current and the estimation value of the threshold current, and
feeding-back a difference between the light amount detection value and the estimation value related to the light amount to an input of the estimation section in order to obtain the estimation value of the threshold current,
wherein the control section includes an inhibit section for inhibiting the feed-back of the difference when the light emission of the semiconductor light emitting element is stopped.

9. The light source device according to claim 1, wherein the control section further makes the semiconductor light emitting element emit light immediately before causing the semiconductor light emitting element to emit a significant emission.

10. The light source device according to claim 1, wherein the control section further includes a measurement section adapted to measure a value of the drive current used in the estimation section.

11. The light source device according to claim 1, wherein the control section further includes a calculation section capable of calculating a value of the drive current used in the estimation section.

12. An image display device comprising
the light source device according to claim 1,
wherein the input value comprises pixel data included in image data.

13. A method of controlling a semiconductor light emitting element by supplying a drive current in accordance with an input value, the method comprising:
(a) calculating a characteristic value representing an input-output characteristic of the semiconductor light emitting element in accordance with a measurement value related to the semiconductor light emitting element;
(b) supplying the semiconductor light emitting element with the drive current based on the characteristic value, the input value, and an estimation value of a threshold current of the semiconductor light emitting element; and
(c) obtaining the estimation value of the threshold current used to supply the semiconductor light emitting element with the drive current using a value of the drive current, a light amount detection value related to an amount of light emitted from the semiconductor light emitting element, and the characteristic value.

14. A control section for controlling a semiconductor light emitting element of a light source device, the control section comprising:
a characteristic value calculation section capable of determining a light amount error corresponding to the difference between a target light amount to be output from the semiconductor light emitting element and an amount detection value of light measured when light is output from the light emitting element in accordance with the input value sent to the light emitting element, and the differential efficiency using an integration value of a product of the light amount error and the input value;
a current supply section adapted to supply the semiconductor light emitting element with a drive current based on the differential efficiency, the input value, and an estimation value of a threshold current of the semiconductor light emitting element, and
an estimation section adapted to obtain the estimation value of the threshold current used by the current supply section using a value of the drive current, a light amount detection value related to an amount of light emitted from the semiconductor light emitting element, and the differential efficiency.

15. The control section according to claim 14, wherein
the current supply section includes
a first circuit capable of determining the threshold current included in the drive current using the estimation value of the threshold current, and
a second circuit capable of determining a surplus current using a current value corresponding to a current command signal output from the characteristic value calculation section and the input value, and
the characteristic value calculation section
determines a present value of a first variable corresponding to the differential efficiency by subtracting a numerical value which is proportional to an integration value of the product of the light amount error and the input value from a previous value of the first variable determined by the characteristic value calculation section, and
outputs a current command signal corresponding to the present value of the first variable to the current supply section.

16. The control section according to claim 14, wherein the characteristic value calculation section uses one of an average value of the input values, an initial setting input value set previously, and a difference between an intermediate value in a range from the minimum input value to the maximum input value and the input value as a calculation input value used when calculating the integration value of the product of the light amount error and the input value.

17. The control section according to claim 14, wherein the characteristic value calculation section performs a weighting operation to obtain the integration value of the product of the light amount error and the input value by multiplying the light amount error with a weighing constant so that a more recent light amount error is given a higher weight in the integration value than a less recent light amount error.

18. The control section according to claim 14, wherein the estimation section comprises a observer which is capable of:
determining an estimation value of the threshold current as an estimation value of a first state variable,
multiplying the difference between the drive current and the estimation value of the threshold current by a value corresponding to the differential efficiency, thereby obtaining an estimated emission amount of the semiconductor light emitting element, and
determining an estimation value of the threshold current using the estimated emission amount.

19. The control section according to claim 18, wherein the estimation section is further capable of determining an estimation value of a second state variable corresponding to an amount of a constant term of a first order differential equation representing a variation in the threshold current.

20. The control section according to claim 14, wherein the estimation section is further capable of:
determining an estimation value related to an amount of light emitted from the semiconductor light emitting element using a value of the drive current and the estimation value of the threshold current, and
feeding-back a difference between the light amount detection value and the estimation value related to the light amount to an input of the estimation section in order to obtain the estimation value of the threshold current,
wherein the control section includes an inhibit section for inhibiting the feed-back of the difference when the light emission of the semiconductor light emitting element is stopped.
